(19) United States
(12) Patent Application Publication
(10) Pub. No.: US 2019/0347091 A1
(43) Pub. Date: Nov. 14, 2019

(54) INFORMATION PROCESSING APPARATUS AND METHOD FOR MANAGING VERSION NUMBER

(71) Applicant: FUJITSU LIMITED, Kawasaki-shi (JP)

(72) Inventors: Masanori Takaoka, Kawasaki (JP); Atsushi Sometani, Kawasaki (JP)

(73) Assignee: FUJITSU LIMITED, Kawasaki-shi (JP)

(21) Appl. No.: 16/382,250

(22) Filed: Apr. 12, 2019

(30) Foreign Application Priority Data
May 11, 2018 (JP) 2018-092614

(51) Int. Cl. G06F 8/71; G06F 8/65; G06F 9/4401

(52) U.S. Cl. CPC G06F 8/71; G06F 9/4411; G06F 8/65

(57) ABSTRACT

An information processing apparatus includes a mount unit, a memory, and a processor. The memory stores therein first identification information of a first interface device and first version number information of firmware installed in the first interface device. The processor compares the first identification information stored in the memory and second identification information of a second interface device mounted on the mount unit with each other. The processor compares, when the first identification information and the second identification information differ from each other, the first version number information stored in the memory and second version number information of firmware installed in the second interface device with each other. The processor revises, when the first version number information and the second version number information differ from each other, the firmware installed in the second interface device to firmware having a first version number indicated by the first version number information.

### CROSS-REFERENCE TO RELATED APPLICATION

This application is based upon and claims the benefit of priority of the prior Japanese Patent Application No. 2018-92614, filed on May 11, 2018, the entire contents of which are incorporated herein by reference.

### FIELD

The embodiment discussed herein is related to an information processing apparatus and a method for managing a version number.

### BACKGROUND

As an interface card for an information processing apparatus such as a computer, a peripheral component interconnect (PCI) card is sometimes used.

FIG. 1 is a diagram illustrating an example of a PCI card. An application specific integrated circuit (ASIC) 113 is mounted on a PCI card 102. Firmware 112 for controlling the ASIC 113 is installed on the PCI card 102. An operating system (OS) 101 communicates with the firmware 112 via a PCI bus 103 using a driver 111 for the PCI card 102. The OS 101 controls the ASIC 113 via the firmware 112.

A method of performing version ensuring consistency between a driver and firmware is known. A method of downloading software of a version operated in an apparatus as firmware of a module is known.

Related techniques are disclosed in, for example, Japanese Laid-open Patent Publication No. 2007-293514 and Japanese Laid-open Patent Publication No. 2005-71042.

When a PCI card fails, the failed PCI card is replaced by a new PCI card. However, when the version number of firmware of the new PCI card is inconsistent with the version number of a driver, the operation of the new PCI card is sometimes different from the operation of the failed PCI card or the new PCI card sometimes does not operate.

This problem occurs not only in the case of the replacement of a PCI card but also in the case of the replacement of another interface device mounted in an information processing apparatus.

### SUMMARY

According to an aspect of the present invention, provided is an information processing apparatus including a mount unit, a memory, and a processor coupled to the memory. The mount unit includes at least one slot in which an interface device is mounted. The memory is configured to store therein first identification information of a first interface device and first version number information of firmware installed in the first interface device. The first interface device is any one of at least one interface device. The processor is configured to compare the first identification information stored in the memory and second identification information of a second interface device mounted in any one of the at least one slot with each other. The processor is configured to compare, when the first identification information and the second identification information differ from each other, the first version number information stored in the memory and second version number information of firmware installed in the second interface device with each other. The processor is configured to revise, when the first version number information and the second version number information differ from each other, the firmware installed in the second interface device to firmware having a first version number indicated by the first version number information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a PCI card;

FIG. 2 is a diagram illustrating replacement of a PCI card;

FIG. 3 is a diagram illustrating an exemplary functional configuration of an information processing apparatus;

FIG. 4 is a flowchart illustrating an exemplary firmware revision process;

FIG. 5 is a diagram illustrating an exemplary hardware configuration of an information processing apparatus;

FIG. 6 is a diagram illustrating a nonvolatile memory included in a PCI card;

FIG. 7 is a diagram illustrating a transportable recording medium;

FIG. 8 is a diagram illustrating PCI card information;

FIG. 9 is a diagram illustrating a writing program;

FIG. 10 is a diagram illustrating version number management information;

FIG. 11 is a flowchart illustrating a writing process;

FIG. 12 is a flowchart illustrating a startup process; and

FIG. 13 is a flowchart illustrating a concrete example of a firmware revision process.

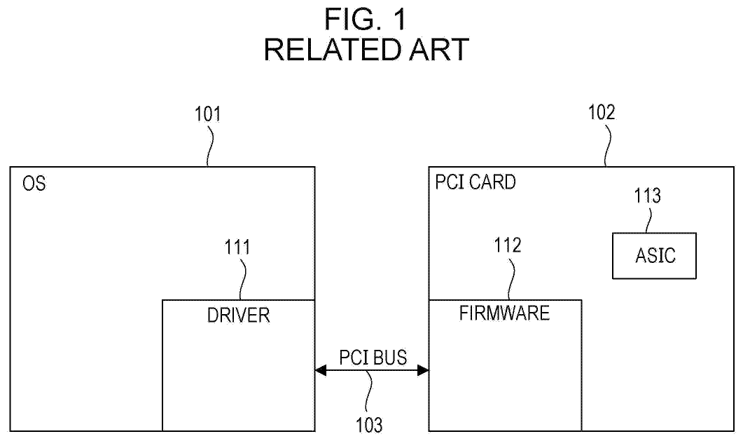

### DESCRIPTION OF EMBODIMENT

An embodiment will be described in detail below with reference to the accompanying drawings. In a case where a new function is added to a PCI card or an OS for an information processing apparatus is changed to a new OS, firmware and a driver for the PCI card are sometimes revised at the same time. In a case where a PCI card fails, the failed PCI card is replaced by a new PCI card.

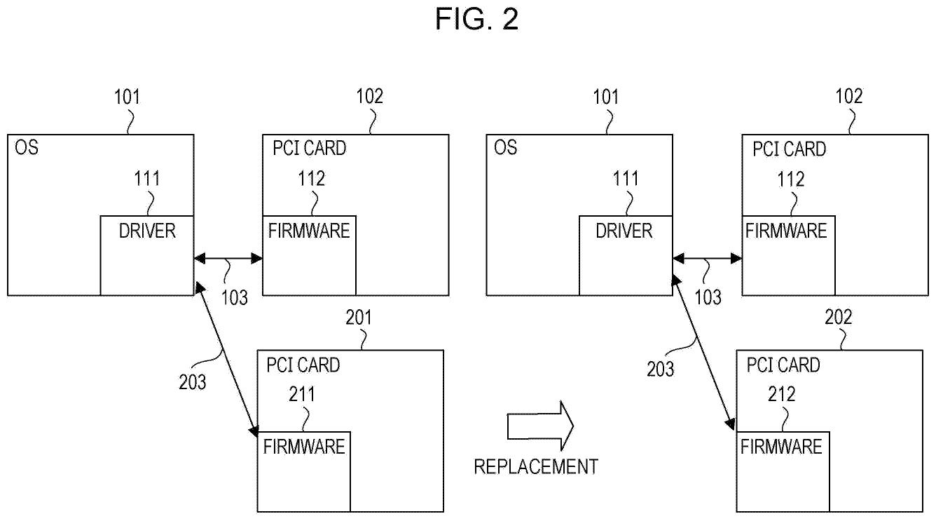

FIG. 2 is a diagram illustrating replacement of a PCI card. The PCI card 102 and a PCI card 201 are mounted in an information processing apparatus. The firmware 112 is installed on the PCI card 102. Firmware 211 is installed on the PCI card 201. The OS 101 communicates with the firmware 112 using the driver 111 via the PCI bus 103 and communicates with the firmware 211 using the driver 111 via a PCI bus 203.

In a case where the PCI card 201 fails during the operation of the information processing apparatus, the PCI card 201 is replaced by a new PCI card 202. Since the version number of the firmware 211 in the PCI card 201 is unknown, a PCI card on which firmware 212 of the newest version is installed is sometimes used as the PCI card 202 to be used for the replacement.

A management server may monitor a PCI card in a server to be monitored via a network and update firmware in the PCI card via the network when the version of the firmware is not the newest version.

However, in a case where the version number of firmware in a failed PCI card is unknown, it is unknown whether firmware in a PCI card by which the failed PCI card is replaced is to be revised. Even if the firmware in the PCI card after the replacement is to be revised, it is unknown to which version the PCI card after the replacement is to be revised. If an information processing apparatus is activated in this state, the PCI card operates under a state where the version number of the firmware after the replacement does not match the version number of the firmware before the replacement and the operation of the PCI card sometimes changes. A case also sometimes occurs where the firmware is not started up because of version number inconsistency between the firmware and a driver.

PCI card vendors usually guarantee the operations of PCI cards in predetermined combinations of an OS, the version number of a drive, and the version number of firmware in a PCI card. Accordingly, when the replacement of a PCI card is performed, it is preferably determined whether the version number of firmware is consistent with an OS and the version number of a driver.

The replacement of a failed PCI card is performed by an operator, such as a customer engineer (CE). In order to check whether the version number of firmware in a new PCI card, by which the failed PCI card is replaced, is consistent with an OS and the version number of a driver, the CE requests a customer-side system administrator to start up the OS. It is therefore desirable that the CE ensures consistency only by the operation of the CE without starting up the OS.

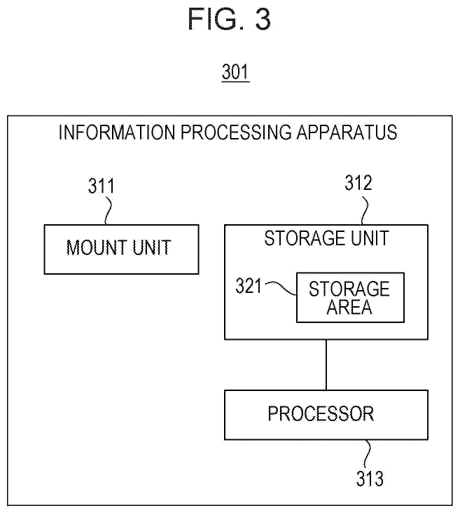

FIG. 3 is a diagram illustrating an exemplary functional configuration of an information processing apparatus according to the embodiment. An information processing apparatus 301 illustrated in FIG. 3 includes a mount unit 311, a storage unit 312, and a processor 313. An interface device is mounted on the mount unit 311. The storage unit 312 includes a storage area 321 for a basic input/output system and stores, in the storage area 321, first identification information of a first interface device and first version number information of firmware in the first interface device. The processor 313 performs a firmware revision process using information stored in the storage unit 312.

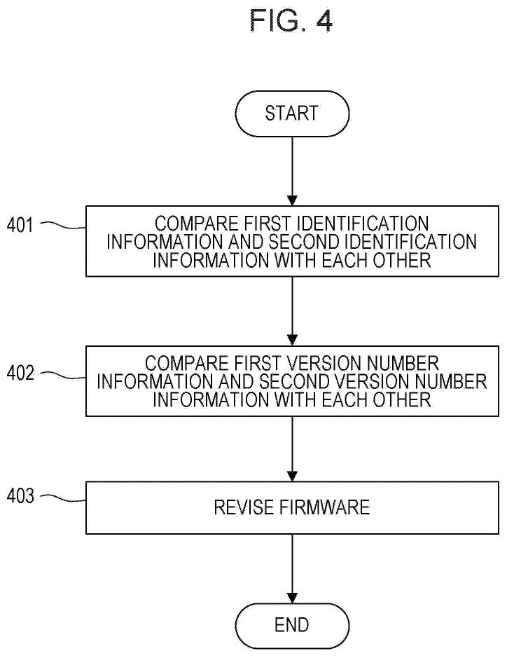

FIG. 4 is a flowchart illustrating an exemplary firmware revision process performed by the information processing apparatus 301 illustrated in FIG. 3. First, the processor 313 compares the first identification information stored in the storage unit 312 and second identification information of a second interface device mounted on the mount unit 311 with each other (step 401).

In a case where the first identification information and the second identification information differ from each other, the processor 313 compares the first version number information stored in the storage unit 312 and second version number information of firmware in the second interface device with each other (step 402). In a case where the first version number information and the second version number information differ from each other, the processor 313 revises the firmware in the second interface device to firmware having the first version number information (step 403).

The information processing apparatus 301 illustrated in FIG. 3 may ensure consistency between the firmware in the interface device mounted in the information processing apparatus 301 and a driver.

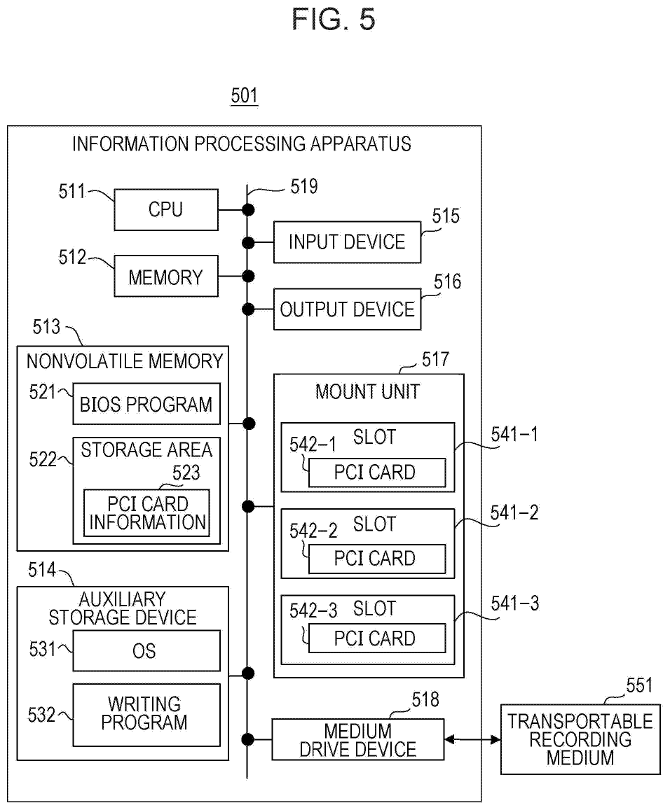

FIG. 5 is a diagram illustrating the exemplary hardware configuration of the information processing apparatus 301 illustrated in FIG. 3. An information processing apparatus 501 illustrated in FIG. 5 includes a central processing unit (CPU) 511, a memory 512, a nonvolatile memory 513, an auxiliary storage device 514, an input device 515, an output device 516, a mount unit 517, and a medium drive device 518. These components are coupled to each other via a bus 519.

The memory 512 is, for example, a semiconductor memory such as a random access memory (RAM). The nonvolatile memory 513 is, for example, a semiconductor memory such as a read-only memory (ROM).

The nonvolatile memory 513 stores a basic input/output system (BIOS) program 521. The nonvolatile memory 513 includes a storage area 522 for storing information used by the BIOS program 521 and stores PCI card information 523 in the storage area 522.

When the information processing apparatus 501 is powered on, the CPU 511 (processor) reads the BIOS program 521 from the nonvolatile memory 513 and executes the BIOS program 521.

The auxiliary storage device 514 is, for example, a magnetic disk device, an optical disc device, a magneto-optical disk device, or a tape device. The auxiliary storage device 514 may be a hard disk drive. The auxiliary storage device 514 stores therein an OS 531 and a writing program 532. The CPU 511 loads the writing program 532 from the auxiliary storage device 514 into the memory 512 and executes the writing program 532, thereby writing the PCI card information 523 in the storage area 522 of the nonvolatile memory 513.

The input device 515 is, for example, a keyboard or a pointing device and is used to receive input of an instruction or information performed by a user. The output device 516 is for example, a display device, a printer, or a speaker and is used to output an inquiry to an operator or a user or output a processing result.

The mount unit 517 includes slots 541-1 to 541-3. A PCI card 542-i is mounted in each slot 541-i (i=1 to 3). The PCI card 542-i is, for example, a network interface card or a storage interface card. The number of the slots 541-i is not limited to three and may be N (N is an integer greater than or equal to 1).

A network interface card is a communication interface circuit that is coupled to a communication network such as a local area network (LAN) or a wide area network (WAN) and performs data conversion in communication. The information processing apparatus 501 may receive a program and data from an external apparatus via the network interface card, load the program and data into the memory 512, and use the program and data.

The medium drive device 518 drives a transportable recording medium 551 and accesses data recorded in the transportable recording medium 551. The transportable recording medium 551 is, for example, a memory device, a flexible disk, an optical disc, or a magneto-optical disk. The transportable recording medium 551 may be a digital versatile disk (DVD), a compact disc read-only memory (CD-ROM), or a universal serial bus (USB) memory. An operator or a user stores a program and data in the transportable recording medium 551 in advance and may load the program and data into the memory 512 and use the program and data.

The memory 512, the nonvolatile memory 513, the auxiliary storage device 514, and the transportable recording medium 551 are physical (non-transitory) recording media and are computer-readable recording media.

The CPU 511, the nonvolatile memory 513, and the mount unit 517 correspond to the processor 313, the storage unit 312, and the mount unit 311 illustrated in FIG. 3, respectively. The storage area 522 corresponds to the storage area 321. The PCI card 542-i corresponds to the first interface device or the second interface device.

As an interface device, not only the PCI card 542-i but also an interface card based on another bus architecture or protocol such as PCI Express, Ethernet®, InfiniBand or Fibre Channel may be used.

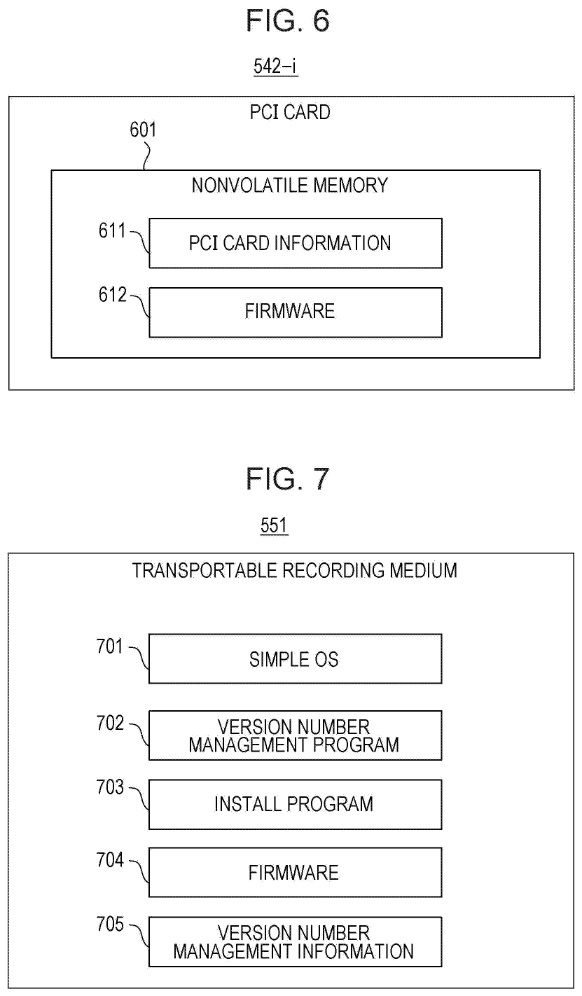

FIG. 6 is a diagram illustrating an example of a nonvolatile memory included in the PCI card 542-i illustrated in FIG. 5. The PCI card 542-i illustrated in FIG. 6 includes a nonvolatile memory 601. The nonvolatile memory 601 stores therein PCI card information 611 and firmware 612. The firmware 612 is a program for controlling an ASIC (not illustrated) mounted on the PCI card 542-i.

FIG. 7 is a diagram illustrating an example of the transportable recording medium 551 illustrated in FIG. 5. The transportable recording medium 551 illustrated in FIG. 7 stores therein a simple OS 701 (maintenance OS), a version number management program 702, an install program 703, pieces of firmware 704, and version number management information 705.

The simple OS 701 is a program used to start up the information processing apparatus 501 from the transportable recording medium 551. The version number management program 702 is used to check the version number of the firmware 612 in each PCI card 542-i and revise the firmware 612. The install program 703 is a program used to install the firmware 612 on each PCI card 542-i.

The pieces of firmware 704 are programs of firmware 612 having various version numbers and installed in the PCI cards 542-i. The version number management information 705 includes, for each of the pieces of firmware 704 having various version numbers, combinations of information about the version number of a driver and information about the version number of firmware. For each combination, the vendor of the PCI card 542-i guarantees operation. With each combination, consistency between firmware and a driver is ensured.

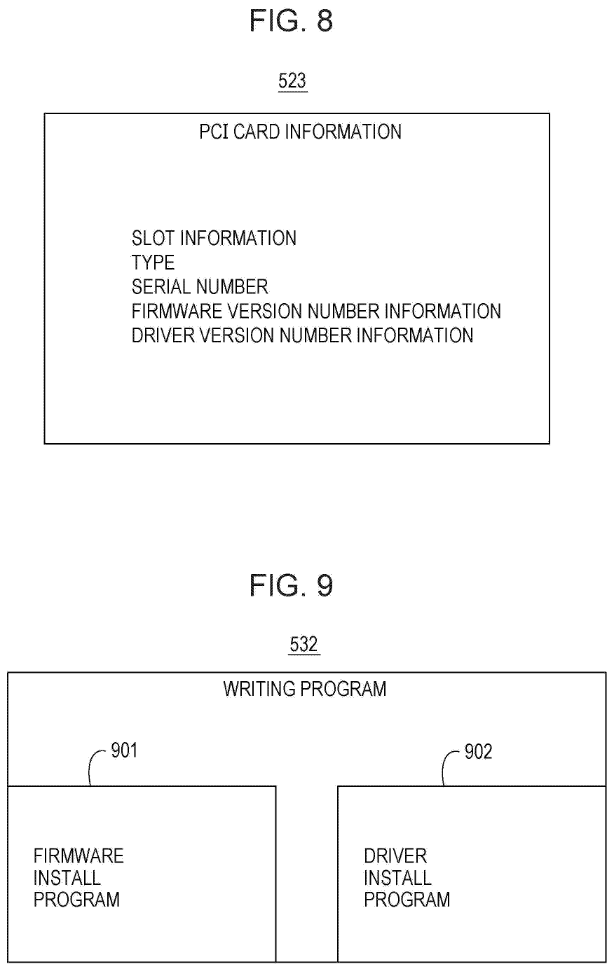

FIG. 8 is a diagram illustrating an example of the PCI card information 523 illustrated in FIG. 5. The PCI card information 523 illustrated in FIG. 8 includes slot information, a type, a serial number, firmware version number information, and driver version number information.

The slot information is identification information of the slot 541-i (i=1 to 3) of the mount unit 517 in which the PCI card 542-i is mounted, and represents the position of the PCI card 542-i in the mount unit 517. The type represents the type of the PCI card 542-i. As the type of the PCI card 542-i, for example, applications such as a network interface or a storage interface may be used.

The serial number is identification information of the PCI card 542-i. The firmware version number information represents the version number of the firmware 612 installed on the PCI card 542-i. The driver version number information represents the version number of a driver which is consistent with the version number of the firmware 612.

The PCI card information 611 illustrated in FIG. 6 includes similar information to the information included in the PCI card information 523 illustrated in FIG. 5.

FIG. 9 is a diagram illustrating an example of the writing program 532 illustrated in FIG. 5. The writing program 532 illustrated in FIG. 9 includes a firmware install program 901 and a driver install program 902. The firmware install program 901 is a program used to install the firmware 612 on each PCI card 542-i. The driver install program 902 is a program used to install a driver for each PCI card 542-i on the auxiliary storage device 514.

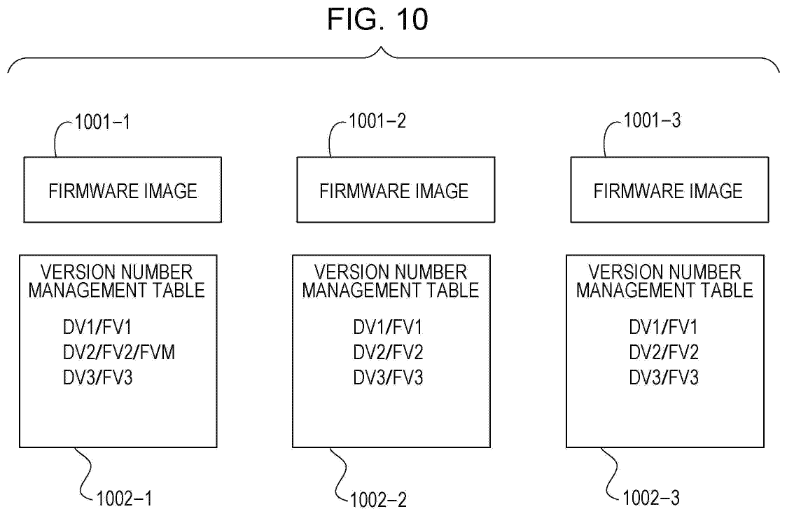

FIG. 10 is a diagram illustrating an example of the version number management information 705 illustrated in FIG. 7. Firmware images 1001-1 to 1001-3 illustrated in FIG. 10 correspond to the pieces of firmware 704 illustrated in FIG. 7. Each firmware image 1001-i includes a plurality of pieces of firmware having various version numbers which are used to control the PCI card 542-i.

Each of version number management tables 1002-1 to 1002-3 corresponds to the version number management information 705 illustrated in FIG. 7. The version number management table 1002-i includes combinations of information about the version number of a driver and information about the version number of firmware, for each of the pieces of firmware in the PCI cards 542-i. In a case where the revision of firmware is performed in a step-by-step manner, the version number management table 1002-i further includes intermediate version number information representing an intermediate version number.

For example, “DV1/FV1” in the version number management table 1002-1 represents a combination of DV1 that is the version number of a driver and FV1 that is the version number of firmware.

“DV2/FV2/FVM” represents a combination of DV2 that is the version number of a driver and FV2 that is the version number of firmware, and also indicates that an intermediate version number FVM between the version numbers FV1 and FV2 is associated with the version number FV2. In order to revise firmware having the version number FV1 to firmware having the version number FV2, firmware having the version number FV1 is not directly updated to firmware having the version number FV2. A step-by-step revision procedure is used for updating firmware having the version number FV1 to firmware having the intermediate version number FVM and then updating firmware having the intermediate version number FVM to firmware having the version number FV2.

“DV3/FV3” represents a combination of DV3 that is the version number of a driver and FV3 that is the version number of firmware. Information in the version number management tables 1002-2 and 1002-3 is similar to the information in the version number management table 1002-1.

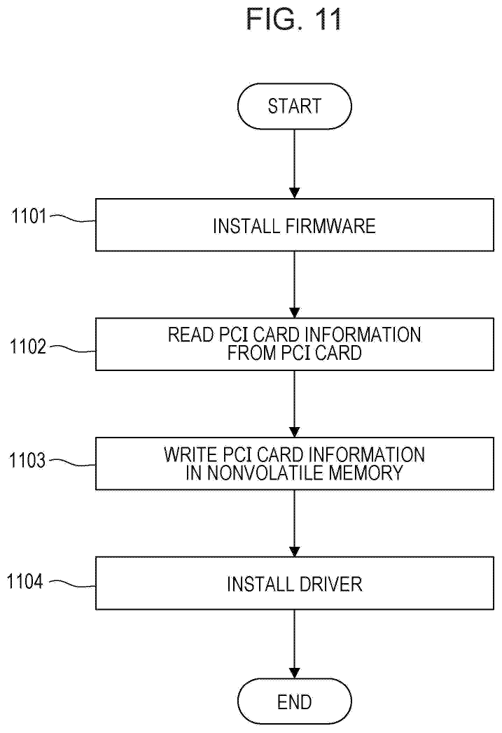

FIG. 11 is a flowchart illustrating an exemplary writing process performed at the time of beginning of the operation of the information processing apparatus 501 or at the time of addition of the PCI card 542-i. The system administrator stores the writing program 532 in the auxiliary storage device 514 included in the information processing apparatus 501 using a terminal such as a workstation to cause the information processing apparatus 501 to execute the writing program 532. The CPU 511 executes the writing program 532 on the OS 531, thereby performing the writing process illustrated in FIG. 11.

First, the CPU 511 executes the firmware install program 901 to install the firmware 612 on the nonvolatile memory 601 in each PCI card 542-i (step 1101). The CPU 511 reads the PCI card information 611 from the nonvolatile memory 601 of the PCI card 542-i (step 1102).

Subsequently, the CPU 511 writes the read PCI card information 611 in the storage area 522 of the nonvolatile memory 513 via an interface program included in the BIOS program 521 (step 1103). As a result, the contents of the PCI card information 611 stored in each PCI card 542-i are written in the PCI card information 523. The interface program is a program used to transfer information between the BIOS program 521 and the OS 531.

Subsequently, the CPU 511 executes the driver install program 902 to install a driver for each PCI card 542-I, on the auxiliary storage device 514 (step 1104).

In a case where a PCI card 542-i fails during the operation of the information processing apparatus 501, a CE performs maintenance replacement to replace the failed PCI card 542-i with a new PCI card of the same type. In this case, the serial number of the new PCI card 542-i mounted in the slot 541-i does not match the serial number in the PCI card information 523 associated with this slot. Accordingly, by comparing the serial number of the PCI card 542-i and the serial number in the PCI card information 523 with each other, it may be determined whether the PCI card 542-i has been replaced.

The CE creates a volume label for maintenance in the transportable recording medium 551 and stores the simple OS 701 in a storage area having the created volume label. The CE attaches the transportable recording medium 551 to the medium drive device 518 of the information processing apparatus 501.

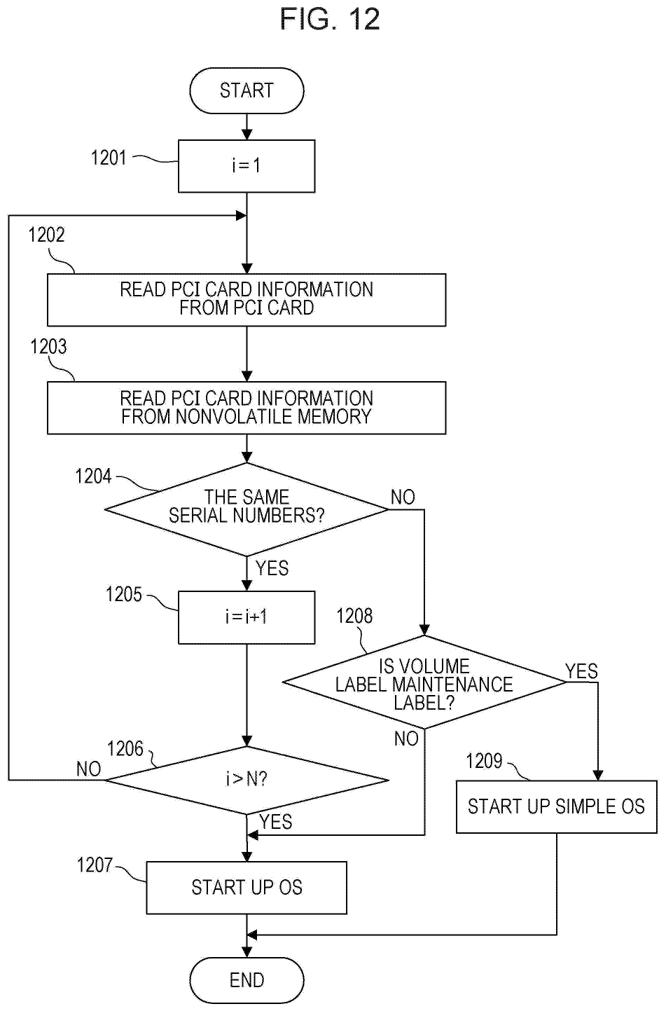

FIG. 12 is a flowchart illustrating an exemplary startup process performed when the information processing apparatus 501, to which the transportable recording medium 551 is attached, is powered on. In this example, it is assumed that N slots 541-i are provided in the mount unit 517 and N PCI cards 542-i are mounted. The CPU 511 executes the BIOS program 521, thereby performing the startup process illustrated in FIG. 12.

First, the CPU 511 sets a control variable i to 1 (step 1201) and reads the PCI card information 611 from the nonvolatile memory 601 of the i-th PCI card 542-i (step 1202). Subsequently, the CPU 511 reads the PCI card information 523 including slot information of the slot 541-i in which the PCI card 542-i is mounted from the storage area 522 of the nonvolatile memory 513 (step 1203). The CPU 511 compares a serial number included in the PCI card information 523 and a serial number included in the PCI card information 611 with each other (step 1204).

In a case where the two serial numbers are the same (YES in step 1204), the CPU 511 increments i by 1 (step 1205) and compares i with N (step 1206). In a case where i is less than or equal to N (NO in step 1204), the process returns to step 1202. In a case where i is greater than N (YES in step 1204), the CPU 511 starts up the OS 531 (step 1207).

In a case where the two serial numbers differ from each other (NO in step 1204), the CPU 511 starts an operation in a maintenance replacement mode and checks a volume label in the transportable recording medium 551 (step 1208). In a case where the volume label is a maintenance label (YES in step 1208), the CPU 511 starts up the simple OS 701 (step 1209). In a case where the volume label is not a maintenance label (NO in step 1208), the CPU 511 starts up the OS 531 (step 1207).

In step 1204, the CPU 511 may compare the type included in the PCI card information 523 and the type included in the PCI card information 611 with each other. In a case where the two types are the same, the CPU 511 may compare serial numbers included in these pieces of PCI card information with each other.

Thus, with the startup process illustrated in FIG. 12, by executing the BIOS program 521 when the information processing apparatus 501 is powered on, it may be determined whether the PCI card 542-i has been replaced. By performing the process from step 1202 to step 1204 for the PCI card 542-i in each slot 541-i, it may be determined whether the PCI card 542-i has been replaced, for all of the PCI cards 542-i mounted on the mount unit 517.

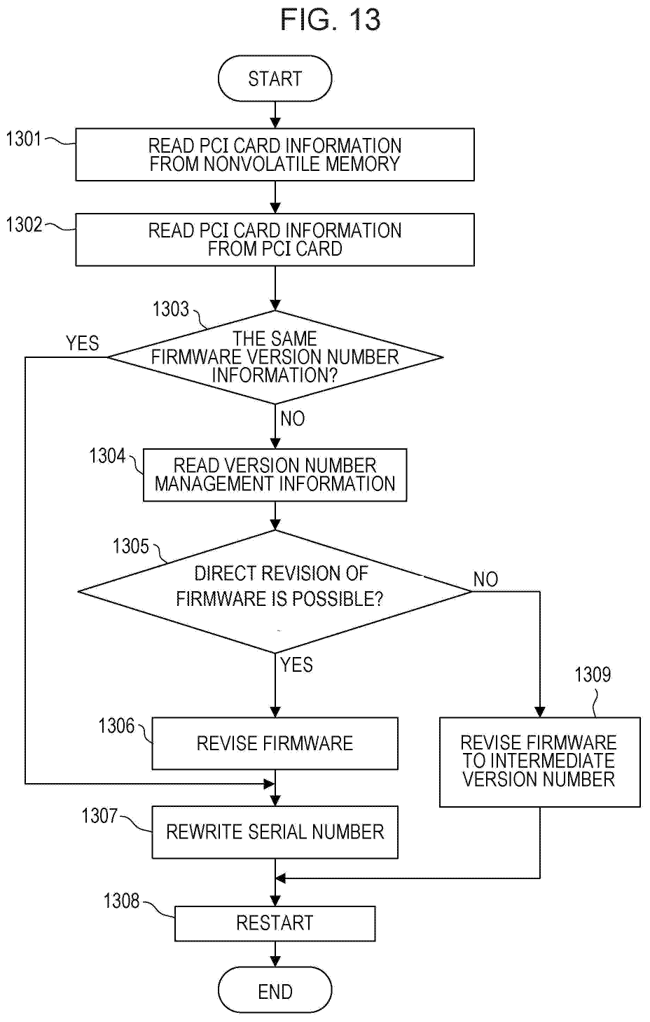

FIG. 13 is a flowchart illustrating a concrete example of a firmware revision process performed when the simple OS 701 has been started up. The CPU 511 executes the version number management program 702 on the simple OS 701, thereby performing the firmware revision process illustrated in FIG. 13.

First, the CPU 511 reads the PCI card information 523 including the slot information of the slot 541-i from the storage area 522 of the nonvolatile memory 513 via the interface program included in the BIOS program 521 (step 1301). Subsequently, the CPU 511 reads the PCI card information 611 from the nonvolatile memory 601 of the PCI card 542-i mounted in the slot 541-i (step 1302).

The CPU 511 compares a version number FVA represented by firmware version number information included in the PCI card information 523 and a version number FVB represented by firmware version number information included in the PCI card information 611 with each other (step 1303). For example, in a case where the version number management information 705 illustrated in FIG. 10 is used, each of the version numbers FVA and FVB corresponds to any one of the version numbers FV1 to FV3.

In a case where FVA and FVB differ from each other (NO in step 1303), the CPU 511 reads the version number management information 705 from the transportable recording medium 551 (step 1304). The CPU 511 refers to the version number management information 705 to check whether the firmware 612 in the PCI card 542-i may be directly revised to firmware having the version number FVA (step 1305).

For example, in a case where intermediate version number information is not associated with the version number FVA, the CPU 511 determines that the firmware 612 may be directly revised to firmware having the version number FVA. On the other hand, in a case where intermediate version number information is associated with the version number FVA, the CPU 511 compares an intermediate version number represented by the intermediate version number information and the version number FVB with each other and determines that the firmware 612 is unable to be directly revised to firmware having the version number FVA when the intermediate version number and FVB differ from each other. In a case where the intermediate version number and FVB are the same, the CPU 511 determines that the firmware 612 may be directly revised to firmware having the version number FVA.

In a case where the firmware 612 may be directly revised to firmware having the version number FVA (YES in step 1305), the CPU 511 revises the firmware 612 in the PCI card 542-i to firmware having the version number FVA (step 1306). At that time, the CPU 511 executes the install program 703, thereby reading firmware having the version number FVA from the pieces of firmware 704 and installing the firmware on the nonvolatile memory 601 of the PCI card 542-i. The CPU 511 rewrites firmware version number information included in the PCI card information 611 stored in the PCI card 542-i to firmware version number information representing the version number FVA.

Subsequently, the CPU 511 accesses the storage area 522 of the nonvolatile memory 513 via the interface program included in the BIOS program 521. The CPU 511 rewrites the serial number included in the PCI card information 523 that includes the slot information of the slot 541-i to a serial number included in the read PCI card information 611 (step 1307). As a result, the serial number in the PCI card information 523 matches the serial number of the PCI card 542-i after replacement.

Subsequently, the CPU 511 restarts the information processing apparatus 501 (step 1308). As a result, the startup process illustrated in FIG. 12 starts. In step 1204, it is determined that a serial number included in the PCI card information 523 and a serial number included in the PCI card information 611 stored in the PCI card 542-i are the same.

In a case where FVA and FVB are the same (YES in step 1303), the CPU 511 does not revise the firmware 612 in the PCI card 542-i and the process proceeds to step 1307.

In a case where the firmware 612 is unable to be directly revised to firmware having the version number FVA (NO in step 1305), the CPU 511 revises the firmware 612 in the PCI card 542-i to firmware having an intermediate version number represented by the intermediate version number information (step 1309). At that time, the CPU 511 executes the install program 703, thereby reading firmware having the intermediate version number from the pieces of firmware 704 and installing the firmware on the nonvolatile memory 601 of the PCI card 542-i. The CPU 511 rewrites firmware version number information included in the PCI card information 611 stored in the PCI card 542-i to firmware version number information representing the intermediate version number.

Subsequently, the CPU 511 restarts the information processing apparatus 501 (step 1308). As a result, the startup process illustrated in FIG. 12 starts. In step 1209, the simple OS 701 is started up to perform the firmware revision process illustrated in FIG. 13 again. In a case where the intermediate version number and FVB are the same in step 1305, the process proceeds to step 1306.

In a case where the failed PCI card 542-i is replaced by a new PCI card in the startup process illustrated in FIG. 12 and the firmware revision process illustrated in FIG. 13, firmware in the new PCI card may be revised to firmware having a version number that is the same as that before the replacement. As a result, consistency between the version number of firmware in the new PCI card and the version number of a driver used by the OS 531 is ensured.

By executing the version number management program 702 on the simple OS 701, the version number of firmware that is consistent with the version number of a driver is automatically acquired from the storage area 522 of the nonvolatile memory 513. Accordingly, a CE may perform the replacement of a PCI card without the presence of a customer-side system administrator and the startup of the OS 531.

Since step-by-step firmware revision in which an intermediate version number is used is automatically performed, a CE may perform the replacement of a PCI card without being aware of a step-by-step firmware revision procedure.

The configuration of an information processing apparatus illustrated in FIGS. 3 and 5 is merely illustrative, and may be partly omitted or changed depending on the applications of the information processing apparatus and conditions. For example, in the information processing apparatus 501 illustrated in FIG. 5, the input device 515 may be omitted in a case where an operator or a user does not perform input of an instruction or information and the output device 516 may be omitted in a case where output of a query to an operator or a user or the output of a processing result is not performed.

Instead of starting up the information processing apparatus 501 from the transportable recording medium 551, it is possible to start up the information processing apparatus 501 using the auxiliary storage device 514 or a preboot execution environment (PXE). In a case where the auxiliary storage device 514 is used, the information processing apparatus 501 stores the simple OS 701 in the auxiliary storage device 514 in advance and loads the simple OS 701 into the memory 512 to execute the simple OS 701. In a case where the PXE is used, an external PXE server distributes the simple OS 701 to the information processing apparatus 501 via a communication network and the information processing apparatus 501 loads the received simple OS 701 into the memory 512 to execute the simple OS 701.

In a case where the auxiliary storage device 514 or the PXE is used, the medium drive device 518 may be omitted.

The nonvolatile memory 601 illustrated in FIG. 6, the transportable recording medium 551 illustrated in FIG. 7, the PCI card information 523 illustrated in FIG. 8, the writing program 532 illustrated in FIG. 9, and the version number management information 705 illustrated in FIG. 10 are merely illustrative. A part of the program or information may be omitted or changed depending on applications of an information processing apparatus or conditions. For example, the driver version number information included in the PCI card information 523 illustrated in FIG. 8 and the intermediate version number information included in the version number management information 705 illustrated in FIG. 10 may be omitted.

The flowcharts illustrated in FIGS. 4 and 11 to 13 are merely illustrative and may be partly omitted or changed in accordance with the configuration of an information processing apparatus and conditions. For example, in the firmware revision process illustrated in FIG. 13, steps 1305 and 1309 may be omitted in a case where the version number management information 705 does not include the intermediate version number information.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus, comprising:
a mount unit including at least one slot in which an interface device is mounted;
a memory configured to store therein first identification information of a first interface device and first version number information of firmware installed in the first interface device, the first interface device being any one of at least one interface device; and
a processor coupled to the memory and the processor configured to:
compare the first identification information stored in the memory and second identification information of a second interface device mounted in any one of the at least one slot with each other;
compare, when the first identification information and the second identification information differ from each other, the first version number information stored in the memory and second version number information of firmware installed in the second interface device with each other; and
revise, when the first version number information and the second version number information differ from each other, the firmware installed in the second interface device to firmware having a first version number indicated by the first version number information.

2. The information processing apparatus according to claim 1, wherein
the memory is further configured to store therein a BIOS program for a basic input/output system, and
the processor is further configured to:
execute the BIOS program, thereby reading the first identification information from the memory, reading the second identification information from the second interface device, and comparing the first identification information and the second identification information with each other.

3. The information processing apparatus according to claim 1, wherein
the processor is further configured to:
start up a simple operating system; and
execute a predetermined program on the simple operating system, thereby reading the first version number information from the memory, reading the second version number information from the second interface device, comparing the first version number information and the second version number information with each other, and revising the firmware installed in the second interface device to the firmware having the first version number.

4. The information processing apparatus according to claim 1, wherein
the processor is further configured to:
revise, when the first version number information and the second version number information differ from each other, the firmware installed in the second interface device to firmware having an intermediate version number between the first version number and a second version number indicated by the second version number information based on version number management information in which intermediate version number information is associated with the second version number information, the intermediate version number being indicated by the intermediate version number information; and
revise the firmware having the intermediate version number to the firmware having the first version number.

5. The information processing apparatus according to claim 1, wherein
the memory stores therein the first identification information of each of the at least one interface device and the first version number information of firmware installed in each of the at least one interface device, and
the processor is further configured to:
compare, for each of the at least one interface device, the first identification information stored in the memory and the second identification information of the second interface device mounted in each of the at least one slot with each other.

6. A non-transitory computer-readable recording medium having stored therein a program that causes a computer to execute a process, the process comprising:
comparing first identification information of a first interface device and second identification information of a second interface device mounted in any one of at least one slot in which an interface device is mounted with each other, the first identification information being stored in a memory, the at least one slot being included in a mount unit;
comparing, when the first identification information and the second identification information differ from each other, first version number information of firmware installed in the first interface device and second version number information of firmware installed in the second interface device with each other, the first version number information being stored in the memory, the first interface device being any one of at least one interface device; and
revising, when the first version number information and the second version number information differ from each other, the firmware installed in the second interface device to firmware having a first version number indicated by the first version number information.

7. The non-transitory computer-readable recording medium according to claim 6, the process further comprising:
executing a BIOS program for a basic input/output system, thereby reading the first identification information from the memory, reading the second identification information from the second interface device, and comparing the first identification information and the second identification information with each other, the BIOS program being stored in the memory.

8. The non-transitory computer-readable recording medium according to claim 6, the process further comprising:
starting up a simple operating system; and
executing a predetermined program on the simple operating system, thereby reading the first version number information from the memory, reading the second version number information from the second interface device, comparing the first version number information and the second version number information with each other, and revising the firmware installed in the second interface device to the firmware having the first version number.

9. The non-transitory computer-readable recording medium according to claim 6, the process further comprising:
revising, when the first version number information and the second version number information differ from each other, the firmware installed in the second interface device to firmware having an intermediate version number between the first version number and a second version number indicated by the second version number information based on version number management information in which intermediate version number information is associated with the second version number information, the intermediate version number being indicated by the intermediate version number information; and
revising the firmware having the intermediate version number to the firmware having the first version number.

10. The non-transitory computer-readable recording medium according to claim 6, wherein
the memory stores therein the first identification information of each of the at least one interface device and the first version number information of firmware installed in each of the at least one interface device, and
the process further comprises:
comparing, for each of the at least one interface device, the first identification information stored in the memory and the second identification information of the second interface device mounted in each of the at least one slot with each other.

11. A method for managing a version number, the method comprising:
comparing, by a computer, first identification information of a first interface device and second identification information of a second interface device mounted in any one of at least one slot in which an interface device is mounted with each other, the first identification information being stored in a memory, the at least one slot being included in a mount unit;
comparing, when the first identification information and the second identification information differ from each other, first version number information of firmware installed in the first interface device and second version number information of firmware installed in the second interface device with each other, the first version number information being stored in the memory, the first interface device being any one of at least one interface device; and
revising, when the first version number information and the second version number information differ from each other, the firmware installed in the second interface device to firmware having a first version number indicated by the first version number information.

12. The method according to claim 11, further comprising:
executing a BIOS program for a basic input/output system, thereby reading the first identification information from the memory, reading the second identification information from the second interface device, and comparing the first identification information and the second identification information with each other, the BIOS program being stored in the memory.

13. The method according to claim 11, further comprising:
starting up a simple operating system; and
executing a predetermined program on the simple operating system, thereby reading the first version number information from the memory, reading the second version number information from the second interface device, comparing the first version number information and the second version number information with each other, and revising the firmware installed in the second interface device to the firmware having the first version number.

14. The method according to claim 11, further comprising:
revising, when the first version number information and the second version number information differ from each other, the firmware installed in the second interface device to firmware having an intermediate version number between the first version number and a second version number indicated by the second version number information based on version number management information in which intermediate version number information is associated with the second version number information, the intermediate version number being indicated by the intermediate version number information; and
revising the firmware having the intermediate version number to the firmware having the first version number.

15. The method according to claim 11, wherein
the memory stores therein the first identification information of each of the at least one interface device and the first version number information of firmware installed in each of the at least one interface device, and the method further comprises:
comparing, for each of the at least one interface device, the first identification information stored in the memory and the second identification information of the second interface device mounted in each of the at least one slot with each other.
